(19) United States
(12) Patent Application Publication
(10) Pub. No.: US 2026/0213863 A1
(43) Pub. Date: Jul. 23, 2026

(54) Digital Signal Quality Metric For AM HD Radio Signal

(71) Applicant: iBiquity Digital Corporaton, Columbia, MD (US)

(72) Inventors: Jeffrey S. Baird, Columbia, MD (US); Paul Peyla, Columbia, MD (US)

(73) Assignee: iBiquity Digital Corporaton, Columbia, MD (US)

(21) Appl. No.: 19/140,749

(22) PCT Filed: Mar. 16, 2023
(86) PCT No.: PCT/US2023/015370

§ 371 Date: Jun. 18, 2025

Related U.S. Application Data
(60) Provisional application No. 63/476,119, filed on Dec. 19, 2022.

(51) Int. Cl. H04H 40/27; H04B 17/336; H04H 20/12; H04H 20/95

(52) U.S. Cl. CPC H04H 40/27; H04B 17/336; H04H 20/12; H04H 20/95; H04H 2201/186

(57) ABSTRACT

Generally described herein are various embodiments of an amplitude modulated (AM) radio Digital Signal Quality Metric (DSQM) system and method for allowing an HD Radio™ receiver to quickly ascertain whether an AM radio broadcast signal is present on an AM broadcast station. Moreover, embodiments of the AM DSQM system and method measure the quality of the AM broadcast signal. In some embodiments, the system and method indicate the quality of the AM digital signal with a range from 0 to 1, with “0” meaning a threshold for listenability and a “1” meaning highest quality for listenable audio. One embodiment also quickly identifies the Service Mode of an AM signal and computes a carrier-to-noise ratio (C/No).

### CROSS REFERENCE TO RELATED APPLICATIONS

This application claims the benefit of the filing date of U.S. Provisional Patent Application No. 63/476,119 filed Dec. 19, 2022, the disclosure of which is hereby incorporated herein by reference.

### BACKGROUND

Digital radio broadcasting technology delivers digital audio and data services to mobile, portable, and fixed receivers. In-band on-channel (IBOC) digital radio broadcasting is one type of audio broadcasting in which signals can be transmitted in a hybrid format, including an analog modulated carrier in combination with a plurality of digitally modulated carriers. IBOC digital radio signals may also be transmitted in an all-digital format wherein the analog modulated carrier is not used. Transmitting in the hybrid format enables broadcasters to transmit analog AM and FM simultaneously with higher-quality and more robust digital signals.

### BRIEF SUMMARY

Generally described herein is an approach for determining digital signal quality using only the digital signal components and enabling quick seek/scan capability. The approach includes collecting digital radio samples and computing the average of the collected samples. The approach also includes obtaining carrier estimates and reference subcarrier estimates, filtering the estimates, and using the filtered estimates to compute noise estimates. The approach also includes obtaining a normalized signal-to-noise ratio based on the estimates to obtain at least one of a digital signal quality metric (DSQM), a service mode or a carrier-to-noise ratio (C/No).

An aspect of the disclosure provides a system for computing a Digital Signal Quality Metric (DSQM) for an amplitude-modulated (AM) in-band on-channel radio receiver. The system includes memory, one or more processor, and a radio receiver configured to perform receiving an input signal, estimating a signal-to-noise ratio (SNR) of the input signal, and computing an output, the output comprising at least one of a digital signal quality metric (DSQM), a service mode or a carrier-to-noise ratio (C/No).

In another example, the radio receiver is further configured to perform determining whether a synchronization lock has been established; and in response to determining that the synchronization lock has been established, determining a time constant for filtering the SNR.

In yet another example, the radio receiver is further configured to perform computing an AM carrier to reference subcarrier power ratio to determine a service mode.

In yet another example, the radio receiver is further configured to perform determining whether the computed AM carrier to reference subcarrier power ratio exceeds a predetermined threshold; in response to the computed AM carrier to reference subcarrier power ratio not exceeding the predetermined threshold, determining that a service mode is a first signal mode where signals are all digital; and in response to the computed carrier to subcarrier power ratio exceeding the predetermined threshold, determining that a service mode is a second signal mode where signals comprise a combination of digital signals and analog signals.

In yet another example, when the service mode is the first signal mode, a first constant is determined for a first carrier-to-noise ratio (C/No) of 51 dB-Hz and a second constant for the first carrier-to-noise ratio is 4 dB higher than the first constant for the first carrier to noise ratio, and when the service mode is the second signal mode, a third constant is determined for a second C/No of 66 dB-Hz and a fourth constant for the second C/No is 4 dB higher than the third constant for the second C/No; and the first, second, third, and fourth constants are used to normalize the estimated SNR of the input signal to a range over which the digital audio signal is decodable.

In yet another example, the DSQM is calculated using the following equation:

$$D S Q {M}_{n} = ( {SNR\_REF}_{n} - {SNR\_REF}_{min} ) / ( {SNR\_REF}_{max} - {SNR\_REF}_{min} )$$

where n is a DSQM block number, REF refers to the reference subcarriers, SNR_REFₙ is the estimated SNR of the input signal, and where SNR_REFₘᵢₙ and SNR_REFₘₐₓ are used to normalize the estimated SNR to a range over which digital audio is decodable, and wherein the first constant is SNR_REFₘᵢₙ for the first signal mode, the second constant is SNR_REFₘₐₓ for the first signal mode, the third constant is SNR_REFₘᵢₙ for the second signal mode, and the fourth constant is SNR_REFₘₐₓ for the second signal mode.

In yet another example, a DSQM block is comprised of 16 BPSK reference symbols.

In yet another example, the DSQM is limited to a value between 0 and 1, wherein 1 represents a highest quality listenable digital audio signal and 0 represents a threshold of listenability.

In yet another example, the SNR is smoothed using time constants and adjusted by a mode-dependent constant to compute the carrier-to-noise ratio (C/No).

Another aspect of the disclosure provides a method for computing a Digital Signal Quality Metric (DSQM) for an AM in-band on-channel radio receiver. The method includes receiving an input signal. The method also includes estimating a signal-to-noise ratio (SNR) of the input signal. The method further includes computing at least one of a digital signal quality metric (DSQM), a service mode and a carrier-to-noise ratio (C/No).

In another example, the method also includes determining whether a synchronization lock has been established and in response to determining that the synchronization lock has been established, determining a time constant for filtering the SNR.

In yet another example, the method also includes computing an AM carrier to reference subcarrier power ratio to determine a service mode.

In yet another example, the method also includes determining whether the computed AM carrier to reference subcarrier power ratio exceeds a predetermined threshold. The method further includes in response to the computed AM carrier to reference subcarrier power ratio not exceeding the predetermined threshold, determining that a service mode is a first signal mode where signals are all digital. The method also includes in response to the computed carrier to reference subcarrier power ratio exceeding the predetermined threshold, determining that a service mode is a second signal mode where signals comprise a combination of digital signals and analog signals.

In yet another example, when the service mode is the first signal mode, a first constant for a first carrier-to-noise ratio (C/No) is 51 dB-Hz and a second constant for the first carrier-to-noise ratio is 4 dB higher than the first const for the first carrier to noise ratio, and when the service mode is the second signal mode, a third constant for a second C/No is 66 dB-Hz and a fourth constant for the second C/No is 4 dB higher than the third constant for the second C/No.

In yet another example, the DSQM is calculated using a following equation:

$$D S Q {M}_{n} = ( {SNR\_REF}_{n} - {SNR\_REF}_{min} ) / ( {SNR\_REF}_{max} - {SNR\_REF}_{min} )$$

where n is a DSQM block number, REF refers to the reference subcarriers, SNR_REFₙ is the estimated SNR of the input signal, and where SNR_REFₘᵢₙ and SNR_REFₘₐₓ are used to normalize the estimated SNR to a range over which digital audio is decodable, and wherein the first constant is SNR_REFₘᵢₙ for the first signal mode, the second constant is SNR_REFₘₐₓ for the first signal mode, the third constant is SNR_REFₘᵢₙ for the second signal mode, and the fourth constant is SNR_REFₘₐₓ for the second signal mode.

In yet another example, the SNR is smoothed using time constants and adjusted by a mode-dependent constant to compute the carrier-to-noise ratio (C/No).

Another aspect of disclosure provides non-transitory machine-readable medium comprising machine-readable instructions encoded thereon for performing a method of computing a Digital Signal Quality Metric (DSQM) for an amplitude modulated (AM) in-band on-channel radio receiver. The method also includes receiving an input signal, estimating a signal-to-noise ratio (SNR) of the input signal and computing at least one of a digital signal quality metric (DSQM), a service mode and a carrier-to-noise ratio (C/No).

In another example, the non-transitory machine-readable medium comprises machine-readable instructions encoded thereon for performing a method of determining whether a synchronization lock has been established; and in response to determining that the synchronization lock has been established, determining a time constant for filtering the SNR.

In yet another example, the non-transitory machine-readable medium comprises machine-readable instructions encoded thereon for performing a method of computing an AM carrier to reference subcarrier power ratio to determine a service mode.

In yet another example, the non-transitory machine-readable medium comprises machine-readable instructions encoded thereon for performing a method of determining whether the computed AM carrier to reference subcarrier power ratio exceeds a predetermined threshold, in response to the computed AM carrier to reference subcarrier power ratio not exceeding the predetermined threshold, determining that a service mode is a first signal mode where signals are all digital; and in response to the computed carrier to subcarrier power ratio exceeding the predetermined threshold, determining that a service mode is a second signal mode where signals comprise a combination of digital signals and analog signals.

### BRIEF DESCRIPTION OF THE DRAWINGS

FIG. 1 depicts a block diagram of an example Layer 1 AM receiver unit according to aspects of the disclosure.

FIG. 2 depicts a block diagram of an example Digital Signal Quality Metric (DSQM) generating system according to aspects of the disclosure.

FIG. 3 depicts a flow diagram of an example method for computing HD Radio™ Digital Signal Quality Metric (DSQM), C/No and service mode according to aspects of the disclosure.

FIG. 4 depicts a flow diagram of an example method for determining service mode and constants according to aspects of the disclosure.

FIG. 5 depicts a flow diagram of an example method for filtering signal-to-noise ratio (SNR) and computing carrier-to-noise ratio (C/No) according to aspects of the disclosure.

FIG. 6 depicts a graph of DSQM accuracy for MA1(hybrid) mode according to aspects of the disclosure.

FIG. 7 depicts a graph of DSQM accuracy for MA3(all digital) mode according to aspects of the disclosure.

FIG. 8 depicts a graph of seek/scan probabilities with respect to an implementation threshold for MA1(hybrid) mode according to aspects of the disclosure.

FIG. 9 depicts a graph of seek/scan probabilities with respect to an implementation threshold for MA3(all digital) mode according to aspects of the disclosure.

### DETAILED DESCRIPTION

Described herein are various embodiments of an AM Digital Signal Quality Metric (DSQM) system and method for allowing an HD Radio™ receiver to quickly ascertain whether an amplitude-modulated (AM) radio broadcast signal is present on an AM broadcast station. Moreover, embodiments of the AM DSQM system and method measure the quality of the AM broadcast signal. In some embodiments, the system and method indicate the quality of the AM digital signal with a range from 0 to 1, with “0” meaning the threshold of listenability of digital audio and a “1” meaning the highest quality for listenable digital audio. It also quickly identifies the Service Mode of an AM HD Radio signal.

One unique feature of embodiments of the HD Radio™ AM DSQM system and method is that it determines digital signal quality using the digital signal components. Another unique feature is that it provides a quick way of determining the digital service mode and provides an estimate of C/No. Advantages of these unique features include allowing for a quick presentation of All-Digital service mode audio. In addition, these features allow for quick AM Seek/Scan capability so that digital audio is presented to a listener without any undue delays.

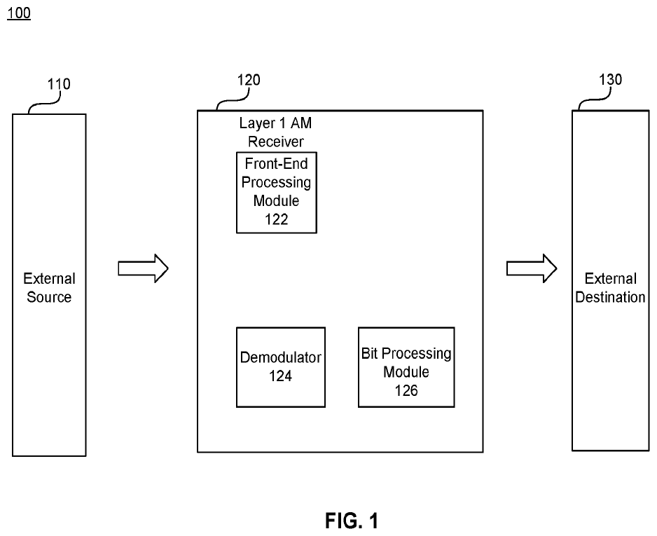

FIG. 1 illustrates a block diagram of an example Layer 1 AM receiver. Layer 1 AM receiver 120 may comprise front-end processing module 122, demodulator 124, and bit processing module 126.

Front-end processing module 122 may receive information related to input time-domain samples, sample rate and the number of samples from external source 110. Front-end processing module 122's processing may comprise isolation filtering, frequency mixing, gain control, etc.

Demodulator 124 may receive information related to digital samples, the number of digital samples, and the available output block from front-end processing module 122. Demodulator 124 may separate the original information of carriers and subcarriers from the received digital samples. Demodulator 124 may transmit deinterleaver matrices such as PL, PU, S, T. and PIDS deinterleaver matrices to bit processing module 126.

Bit processing module 126 may include deinterleaving and Viterbi decoding processes. Viterbi decoding processes may use the Viterbi algorithm to select a code with the minimum distance between the received signal and the selected code. Bit processing module 126 may process the deinterleaver matrices to format content information contained in the received carrier and subcarriers in discrete transfer frames using multiple logical channels, such as logical channels P1, P3 and PIDS. A logical channel may be a signal path that conducts the transfer frames. Service modes may define the logical channels and their associated transmission characteristics. The processed content information may be sent to external destination 330 via each logical channel. Interleaving may refer to a technique for making forward error corrections such as reordering the transmitted digital signal in bits to disperse certain errors encountered when transmitted through a certain channel. For example, the waveforms may be interleaved in both time and frequency. The interleaved output may be structured in a matrix format. However, the interleaved output may lose its respective local channel identifiers. Deinterleaving may include converting interleaved signals back to the state before the signals were interleaved. The deinterleaver matrix may include PL deinterleaver matrix, PU deinterleaver matrix, S deinterleaver matrix, T deinterleaver matrix, and PIDS deinterleaver matrix.

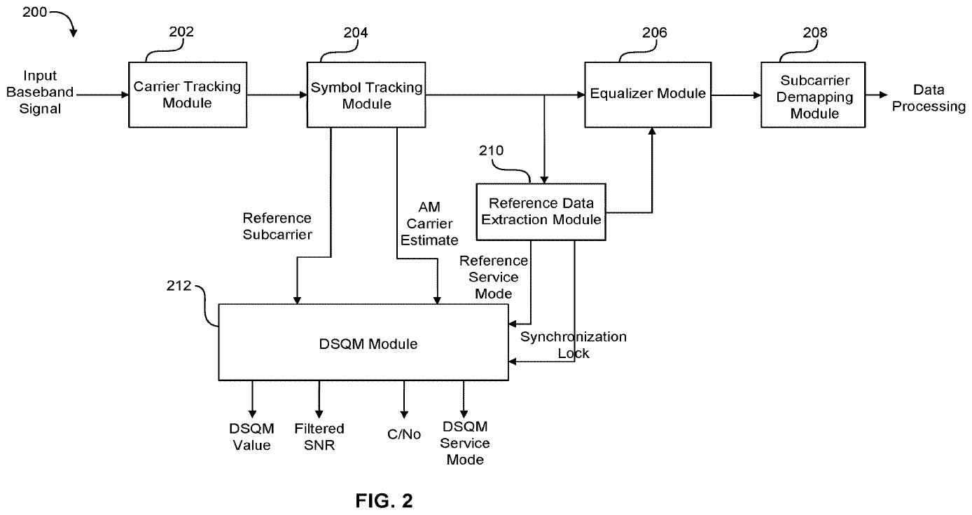

Referring to FIG. 2, FIG. 2 illustrates an example DSQM generating system. According to some examples, DSQM generating system may include carrier tracking module 202, symbol tracking module 204, equalizer module 206, subcarrier de-mapping module 208, reference data extraction module 210, and DSQM module 212. Carrier tracking module 202 may receive an input baseband signal and track the carrier of the baseband signal. Symbol tracking module 204 identifies symbols from the identified subcarrier. Symbol tracking module 204 may send reference subcarrier symbols and carrier amplitudes to DSQM module 212. Symbol tracking module 204 may send information related to the symbols to both equalizer module 206 and reference data extraction module 210. Equalizer module 206 may process the frequency domain symbol received from symbol tracking module 203 and reference data extracted from reference data extraction module 210. The extracted reference data may include Binary Phase Shift Keying (BPSK)-demodulated reference symbols comprising either −1, or 1. The equalized symbol data may be sent to the subcarrier de-mapping module to be de-mapped. The de-mapped data may be transferred to data processing.

DSQM module 212 may receive reference subcarrier service mode and synchronization lock information. Synchronization lock information may refer to a key or flag signal generated when synchronization is achieved, which may indicate that the signals may be decoded into certain data. DSQM module 212 may receive reference subcarrier symbol and carrier amplitude information from symbol tracking module 204. DSQM module 212 may compute and determine DSQM value, filtered signal-to-noise ratio (SNR) and carrier-to-noise ratio (C/NO), and DSQM service mode.

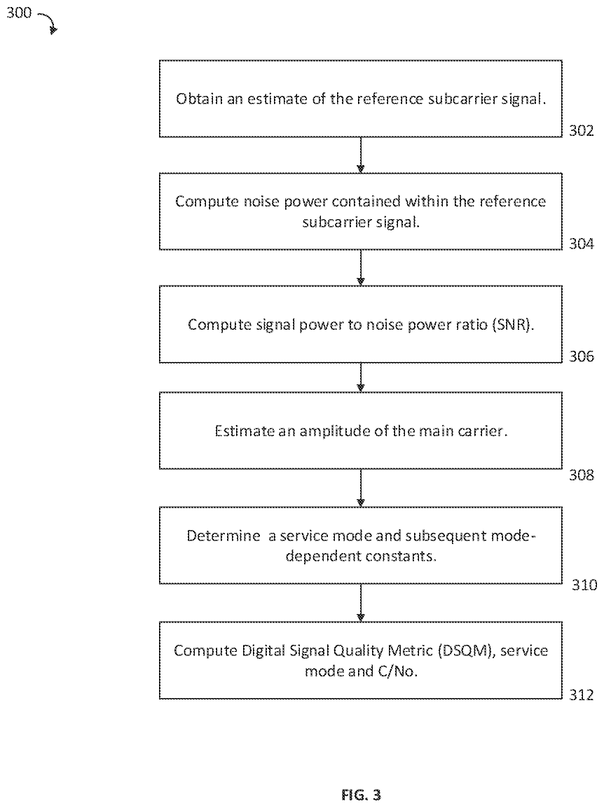

FIG. 3 illustrates a flow diagram of an example method of computing an HD Radio Digital Signal Quality Metric (DSQM), C/No and service mode. According to block 302, an estimate of the reference subcarrier signal may be obtained. Reference subcarriers may be received from symbol tracking module 204. Reference subcarriers may refer to subcarrier information obtained using various digital demodulation techniques, such as Binary Phase Shift Keying (BPSK). BPSK reference subcarriers may refer to reference subcarriers positioned at the location of subcarrier index −1 or 1 or −181.7 or 181.7 Frequency (Hz) in a digital-analog hybrid waveform spectrum.

According to some examples, only the imaginary portion of the complex number of the reference subcarrier symbols may be used as they may be broadcast in quadrature to the analog signal. The imaginary portion may be used to isolate digital symbols from the analog portion of the hybrid signal. As shown in the equation below using a BPSK reference subcarrier as an example reference subcarrier, binary modulation information may be removed by performing an absolute value operation.

$$α n , k = \vert Im ( BPSKn , k ) \vert \qquad Equation 1$$

In one example, “n” may refer to a sequential DSQM block number of 16 symbols and “k” may be symbols within the DSQM block in the binary form. DSQM block number may refer to a counter or sequential block number between 0 and 16.

The above binary modulation information may be averaged using the equation below:

$${\overline{BPSK}}_{n} = \frac{1}{16} {\sum }_{k = 0}^{15} {a}_{n , k} \qquad Equation 2$$

An arithmetic mean of 16 individual reference symbols may be sufficient to produce an estimate using the above equation. However, it is to be understood that the number of individual reference symbols may be any number of reference symbols.

According to block 304, noise power contained within the reference subcarrier signal may be computed. By using the average value of the reference signal computed using the equation 2, the noise power contained within the reference signal may be calculated using the equation below.

$${σ}_{n}^{2} = \frac{1}{15} {\sum }_{k = 0}^{15} {( {a}_{n k} - {\overline{BPSK}}_{n} )}^{2} \qquad Equation 3$$

According to block 306, a signal power-to-noise power ratio (SNR) may be computed. “σₙ²” above may represent a noise power, and a signal power to the noise power ratio may be determined as given in the equation below.

$${SNR\_BPSK}_{n} = ( \frac{{( {\overline{BPSK}}_{n} )}^{2}}{{σ}_{n}^{2}} ) \qquad Equation 4$$

Signal to noise ratio (SNR) may refer to the ratio of signal power to the noise power. SNR may be expressed in decibels (dB). If the ratio is greater than 0, there is more signal than noise.

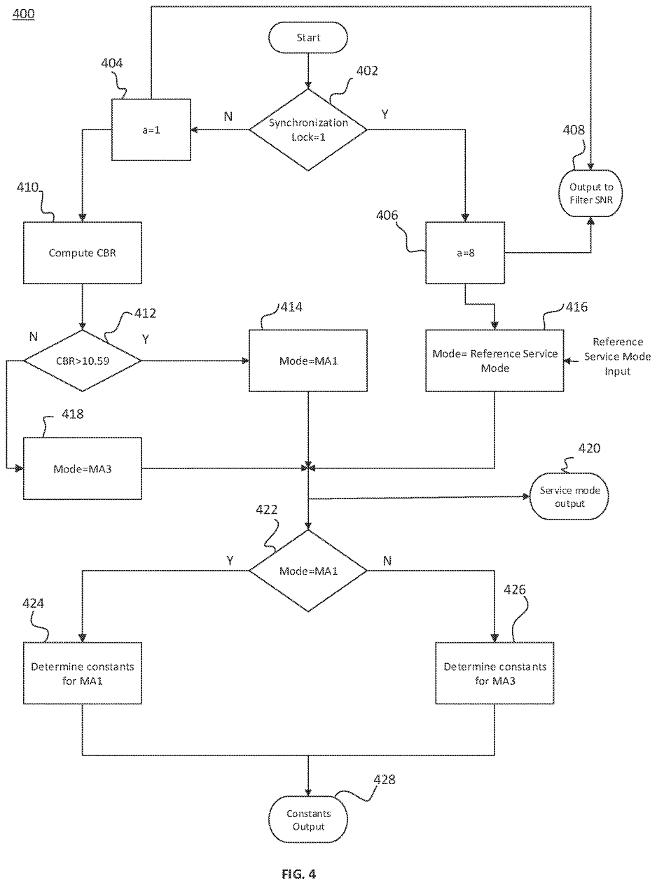

The SNR computed using equation 4 is for the reference signal and it may be used as the basis for the DSQM and the C/NO metrics. To compute the DSQM and the C/NO metrics, the service mode needs to be identified. There are two possible service modes for an AM digital radio signal, MA1 and MA3. MA1 mode may refer to hybrid mode where analog signal and digital signal are broadcast together. MA3 mode may refer to all digital mode where only digital signal is broadcast. The service mode may not be determined quickly enough using only reference subcarriers, as several DSQM blocks may be required to decode such information. In such a case, an alternate approach may be used to get a reliable, quicker estimate of service mode. The approach for identifying the correct service mode is further discussed in reference to FIG. 4 below.

According to block 308, an amplitude of the main carrier signal is estimated using the equation below.

$${\overline{Carrier}}_{n} = \frac{1}{16} {\sum }_{k = 0}^{15} R e ( {Carrier}_{n , k} ) \qquad Equation 5$$

In one example, k may refer to symbols within “block number “n” and “n” may be a DSQM block number. 16 symbols may be selected, and the sum of the carrier symbols within a DSQM block may be used to compute an arithmetic mean of the carrier signal.

According to block 310, a service mode and subsequent mode-dependent constants may be determined. The subsequent mode-dependent constants may include the minimum and maximum parameters of reference subcarrier SNRs for each mode, MA1 and MA3. According to some examples, the minimum SNR value for MA1 may be 219.79 in case BPSK reference subcarriers are used. The maximum SNR value for MA1 may be 552.08. The minimum SNR value for MA3 may be 87.5 and the maximum SNR value of MA3 may be 219.79. The method for determining the above mode-dependent constants is further described in more detail in reference to FIG. 4 below.

According to block 312, a DSQM, service mode and C/No may be computed. The DSQM may be computed using the equation below.

$$D S Q {M}_{n} = ( {SNR\_BPSK}_{n} - {SNR\_BPSK}_{min} ) / ( {SNR\_BPSK}_{max} - {SNR\_BPSK}_{min} ) \qquad Equation 6$$

The above equation may be further solved using the following equation.

$$\begin{matrix}DSQM = 0 , & if DSQM <= 0 \\ DSQM = DSQM , & if 0 < DSQM <= 1 \\ DSQM = 1 , & if DSQM > 1\end{matrix} \qquad Equation 7$$

If the computed value is less than 0, DSQM may be determined to be “0”. If the computed value is between 0 and 1, then the DSQM may be determined to be the computed value (e.g., 0.3, 0.5, 0.78, etc.). If the computed value is above 1, then the DSQM may be determined to be “1”. Thus, the determined DSQM may indicate the quality of the AM digital signal with a range from 0 to 1, with “0” representing a threshold of listenability and a “1” representing highest quality listenable audio. Any number in between 0 and 1 may indicate the quality of the digital signal, with the value closer to 1 meaning better quality audio.

FIG. 4 depicts a flow diagram of an example method of determining service mode and constants. According to block 402, a receiver may determine whether or not synchronization lock is achieved. If synchronization lock is not achieved, a quicker mode of computing a service mode may be used by proceeding to block 404.

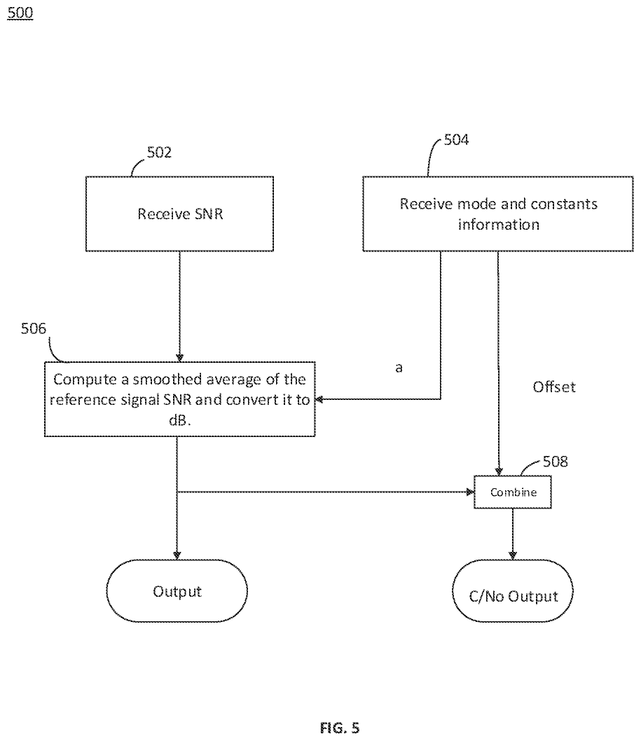

According to block 406, if synchronization lock is determined to be 1 or true, the time constant ‘a’ may be determined to be “8”. It is to be understood that the time constant may be any other power of two numbers such as 4 or 16. According to block 404, If synchronization lock is not determined at block 402, the constant “a” may be determined to be “1”, in which case there is no filtering. The determined constant values may be sent as an output to compute filtered SNR as discussed in reference to FIG. 5 below.

If synchronization lock is not yet achieved, a carrier estimate to reference subcarrier estimate ratio (CBR) may be computed at block 410. For example, the carrier estimate may be computed using the above equation 5 and the reference subcarrier estimate may be computed using the above equation 2. CBR may be computed by dividing the carrier estimate by the reference subcarrier estimate.

According to block 412, if CBR exceeds 10.59, the service mode may be determined to be MA1 (i.e., hybrid mode, comprising both analog and digital signals) at block 414. If CBR is less than or equal to 10.59, the service mode may be determined to be MA3 (i.e., all-digital signals) at block 418. The determined service mode may be output as service mode output at block 420. Alternatively, the service mode obtained via steps 402-416 may be output to 420 once synchronization lock is achieved. The computed service mode may then be used by a receiver to quickly tune into an all digital channel while minimizing the output of audible noise from the receiver due to the absence of the analog host signal.

According to block 422, if the mode is MA1, the constants for MA1 may be determined at block 424. If the mode is not MA1, the constants for MA3 may be determined at block 426. The constants may be output as constants output for DSQM calculation as described above in reference to FIG. 3. Additionally, a C/No offset value for each mode may be determined. For example, for MA1, the offset value may be 42.58 dB and the offset value of C/No for MA3 may be 31.58 dB. The C/No offset values may be computed using the following equation.

$$C / No = ( BPSK * {Sig}_{diff} ) / ( ( 4 * {σ}^{2} ) / ( fs / 256 ) ) \qquad Equation 8$$

Equation 8 may be solved as follows:

$$\begin{matrix}C / No = ( BPS {K}^{2} / {σ}^{2} ) * ( {Sig}_{diff}^{2} * fs / ( 4 * 256 ) ) \\ C / No\_DB = LT\_REF \_SNRdB + 42.58 dB - Hz for MA 1 \\ C / No\_DB = LT\_REF \_SNRdB + 31.58 dB - Hz for MA 3\end{matrix}$$

The noise power computed using equation 3 may be computed from the imaginary components of reference subcarriers 1 and −1. The signal scale difference factor Sig_{diff} may be equal to the difference in signal levels between the AM carrier and the reference subcarriers, such as BPSK reference subcarriers. For example, in service mode MA1, the difference may be 26 dB and in service mode MA3, the difference may be 15 dB. The bandwidth of one subcarrier may be equal to fs/256, where fs=46.51171875 kHz. The above computed C/No values may be used in digital to analog blending to determine when to blend from digital audio.

FIG. 5 depicts a flow diagram of an example method for filtering SNR and computing carrier-to-noise ratio. According to block 502, SNR may be determined. The SNR may refer to the same SNR value computed according to block 306 of FIG. 3. According to block 504, the mode and constant information may refer to the same mode and constant information determined according to blocks 412-428 of FIG. 4.

According to block 506, the SNR may be filtered by smoothing the average of the reference signal SNR. The calculation may be a simple single-pole lossy integration with a time constant of “1/a”, where “a” is determined at blocks 404 and 406 in FIG. 4. The calculation may be based on the equations below.

$$LT\_REF {\_SNR}_{n} = ( \frac{1}{a} ) * {SNR\_BPSK}_{n} + ( 1 - \frac{1}{a} ) * LT\_REF {\_SNR}_{n - 1} \qquad Equation 9$$

Before synchronization lock is established, a=1, and thus unusable SNR values may not corrupt the smoothed SNR. If block lock is established, a=8 or may be other values. In some examples, the smoothed SNR may be converted to dB units using the following equation.

$$LT\_REF \_SNR {\_dB}_{n} = 1 {0}^{*} {log}_{10} ( LT\_REF {\_SNR}_{n} ) \qquad Equation 10$$

According to block 508, the C/No may be computed by adding the filtered average of the reference signal SNR in dB to the C/No offset value. The C/No offset values may include a signal scale difference factor and a noise conversion factor from N to No (e.g., 1-Hz bandwidth).

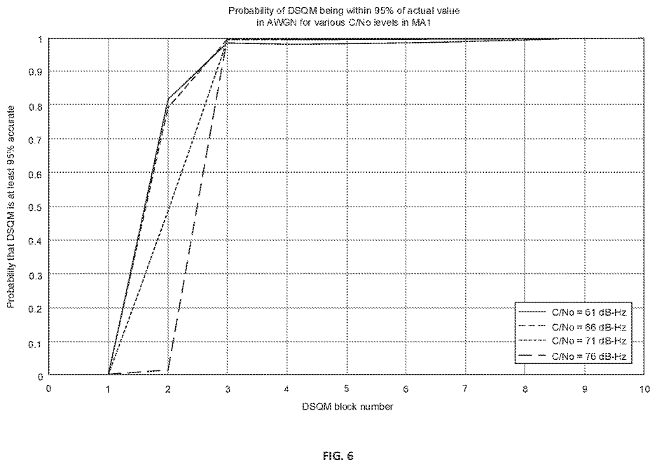

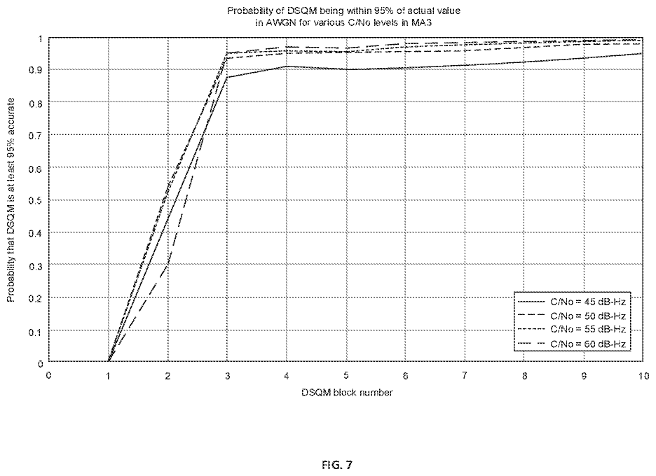

FIGS. 6-7 depict graphs representing a number of DSQM blocks to achieve a reliable DSQM for each service mode MA1 and MA3. In one example, the DSQM value may be calculated once every 16 symbols. However, due to initial latency in frequency and symbol tracking time within a radio receiver, it may be possible that the initial DSQM values may be corrupted. In order to find a point where the DSQM values may be considered reliable, using 1000 trials per different C/No level, statistics may be calculated for DSQM and service mode accuracy. FIGS. 6-7 depict graphs representing the probability that the DSQM is within 95 percent of the actual values versus the DSQM block number for different SNRs. In both service modes MA1 and MA3, the DSQM may be usable by block number 3 regardless of the differences in SNR values. This may imply that a DSQM value may be available within about 300 milliseconds after radio receiver tuning.

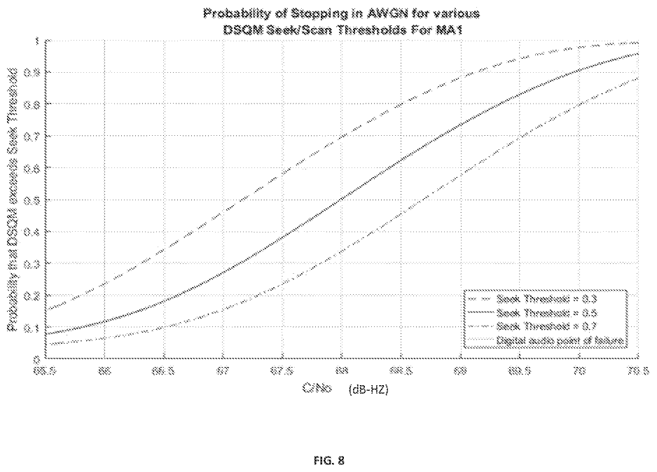

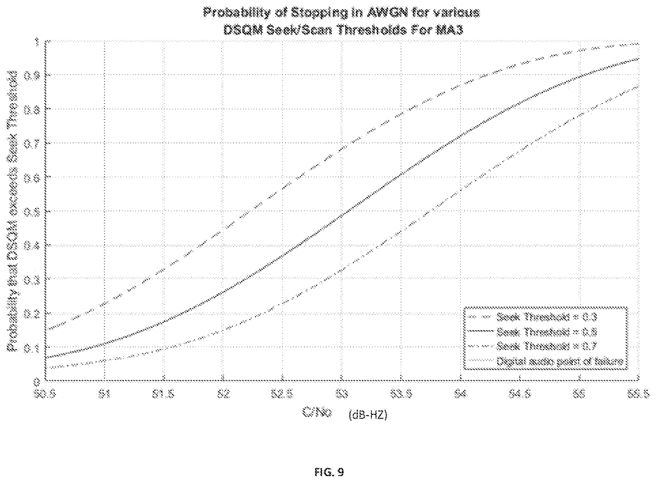

FIGS. 8-9 depict graphs representing seek/scan probabilities of stopping for various DSQM Seek/Scan thresholds for each service mode MA1 and MA3. According to some examples, the DSQM value may be used to assess digital signal viability for seek/scan applications. A typical seek function may increment the tuner frequency to each channel across the AM band until a useful signal may be detected. In some examples, the DSQM may be computed at each channel frequency location, and if the DSQM value exceeds a predetermined seek threshold (e.g., a value between 0 and 1), then the tuner may stop on the frequency and may proceed to process the signal.

FIGS. 8-9 may represent a family of curves plotting the probability of stopping on a channel for different C/No using different threshold values (0.3, 0.5, and 0.7) in each service mode MA1 and MA3. Any type of radio receiver may have the flexibility to adjust the threshold values between 0.3 and 0.7. When the threshold value is set at 0.3, a more aggressive signal search may be possible. The threshold value of 0.7 may enable the receiver to stop only on better quality signals. This time constant may be varied between band scans, such as between a first seek operation and a second seek operation. For example, the less aggressive threshold could eventually be adjusted to the more aggressive threshold after several unsuccessful seek operations. The digital signal may be at the threshold of audio being decodable when C/No=66 dB-Hz in service mode MA1 and C/No=51 dB-Hz in service mode MA3. For example, in service mode MA1, if C/No=66 dB-Hz and the threshold is 0.5, the probability of the tuner finding a viable signal on that channel is about 0.1. In service mode MA3, if C/No=51 dB-Hz and the threshold is 0.5, the probability is about 0.1 as well. However, if a channel with C/No=70 dB-Hz is tuned to in service mode MA1 or a channel with C/No=55 dB-Hz is tuned to in service mode MA3, the probability may increase to about 0.9, which may indicate high probabilities of finding viable signals on those channels.

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the HD Radio AM DSQM system and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Blu-ray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal. Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the HD Radio DSQM system and method described herein, or portions thereof, may be stored, received, transmitted, or read from any desired combination of computer or machine-readable media or storage devices and communication media in the form of computer executable instructions or other data structures.

Embodiments of the HD Radio DSQM system and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

1. A system for computing a Digital Signal Quality Metric (DSQM) for an amplitude modulated (AM) in-band on-channel radio receiver, the system comprising:
memory;
one or more processors;
a radio receiver configured to perform:
receiving an input signal;
estimating a signal-to-noise ratio (SNR) of the input signal; and
computing an output, the output comprising at least one of a digital signal quality metric (DSQM), a service mode or a carrier-to-noise ratio (C/No).

2. The system of claim 1, wherein the radio receiver is further configured to perform:
determining whether a synchronization lock has been established; and
in response to determining that the synchronization lock has been established, determining a time constant for filtering the SNR.

3. The system of claim 1, wherein the radio receiver is further configured to perform:
computing an AM carrier to reference subcarrier power ratio to determine a service mode.

4. The system of claim 3, wherein the radio receiver is further configured to perform:
determining whether the computed AM carrier to reference subcarrier power ratio exceeds a predetermined threshold;
in response to the computed AM carrier to reference subcarrier power ratio not exceeding the predetermined threshold, determining that a service mode is a first signal mode where signals are all digital; and
in response to the computed carrier to subcarrier power ratio exceeding the predetermined threshold, determining that a service mode is a second signal mode where signals comprise a combination of digital signals and analog signals.

5. The system of claim 4, wherein when the service mode is the first signal mode, a first constant is determined for a first carrier to noise ratio (C/No) of 51 dB-Hz and a second constant for the first carrier to noise ratio is 4 dB higher than the first constant for the first carrier to noise ratio, and wherein when the service mode is the second signal mode, a third constant is determined for a second C/No of 66 dB-Hz and a fourth constant for the second C/No is 4 dB higher than the third constant for the second C/No; and wherein the first, second, third, and fourth constants are used to normalize the estimated SNR of the input signal to a range over which the digital audio signal is decodable.

6. The system of claim 5, wherein the DSQM is calculated using a following equation:
$$D S Q {M}_{n} = ( {SNR\_REF}_{n} - {SNR\_REF}_{min} ) / ( {SNR\_REF}_{max} - {SNR\_REF}_{min} )$$
where n is a DSQM block number, REF refers to the reference subcarriers, SNR_REFₙ is the estimated SNR of the input signal, and where SNR_REFₘᵢₙ and SNR_REFₘₐₓ are used to normalize the estimated SNR to a range over which digital audio is decodable, and wherein the first constant is SNR_REFₘᵢₙ for the first signal mode, the second constant is SNR_REFₘₐₓ for the first signal mode, the third constant is SNR_REFₘᵢₙ for the second signal mode, and the fourth constant is SNR_REFₘₐₓ for the second signal mode.

7. The system of claim 6, wherein a DSQM block is comprised of 16 BPSK reference symbols.

8. The system of claim 1, wherein the DSQM is limited to a value between 0 and 1, wherein 1 represents a highest quality listenable digital audio signal and 0 represents a threshold of listenability.

9. The system of claim 2, wherein the SNR is smoothed using time constants and adjusted by a mode-dependent constant to compute the carrier-to-noise ratio (C/No).

10. A method for computing a Digital Signal Quality Metric (DSQM) for an AM in-band on-channel radio receiver, the method comprising:
receiving an input signal;
estimating a signal-to-noise ratio (SNR) of the input signal; and
computing at least one of a digital signal quality metric (DSQM), a service mode and a carrier-to-noise ratio (C/No).

11. The method of claim 10, further comprising:
determining whether a synchronization lock has been established; and
in response to determining that the synchronization lock has been established, determining a time constant for filtering the SNR.

12. The method of claim 10, further comprising:
computing an AM carrier to reference subcarrier power ratio to determine a service mode.

13. The method of claim 10, further comprising:
determining whether the computed AM carrier to reference subcarrier power ratio exceeds a predetermined threshold;
in response to the computed AM carrier to reference subcarrier power ratio not exceeding the predetermined threshold, determining that a service mode is a first signal mode where signals are all digital; and
in response to the computed carrier to subcarrier ratio exceeding the predetermined threshold, determining that a service mode is a second signal mode where signals comprise a combination of digital signals and analog signals.

14. The method of claim 13, wherein when the service mode is the first signal mode, a first constant for a first carrier to noise ratio (C/No) is 51 dB-Hz and a second constant for the first carrier to noise ratio is 4 dB higher than the first constant for the first carrier to noise ratio, and wherein when the service mode is the second signal mode, a third constant for a second C/No is 66 dB-Hz and a fourth constant for the second C/No is 4 dB higher than the third constant for the second C/No.

15. The method of claim 11, wherein the DSQM is calculated using a following equation:
$$D S Q {M}_{n} = ( {SNR\_REF}_{n} - {SNR\_REF}_{min} ) / ( {SNR\_REF}_{max} - {SNR\_REF}_{min} )$$
where n is a DSQM block number, REF refers to the reference subcarriers, SNR_REFₙ is the estimated SNR of the input signal, and where SNR_REFₘᵢₙ and SNR_REFₘₐₓ are used to normalize the estimated SNR to a range over which digital audio is decodable, and wherein the first constant is SNR_REFₘᵢₙ for the first signal mode, the second constant is SNR_REFₘₐₓ for the first signal mode, the third constant is SNR_REFₘᵢₙ for the second signal mode, and the fourth constant is SNR_REFₘₐₓ for the second signal mode.

16. The method of claim 11, wherein the SNR is smoothed using time constants and adjusted by a mode-dependent constant to compute the carrier-to-noise ratio (C/No).

17. A non-transitory machine-readable medium comprising machine-readable instructions encoded thereon for performing a method of computing a Digital Signal Quality Metric (DSQM) for an amplitude modulated (AM) in-band on-channel radio receiver, the method comprising:
receiving an input signal;
estimating a signal-to-noise ratio (SNR) of the input signal; and
computing at least one of a digital signal quality metric (DSQM), a service mode and a carrier-to-noise ratio (C/No).

18. The non-transitory machine-readable medium of claim 17, wherein the method further comprises:
determining whether a synchronization lock has been established; and
in response to determining that the synchronization lock has been established, determining a time constant for filtering the SNR.

19. The non-transitory machine-readable medium of claim 17, wherein the method further comprises:
computing an AM carrier to reference subcarrier power ratio to determine a service mode.

20. The non-transitory machine-readable medium of claim 17, wherein the method further comprises:
Determining whether the computed AM carrier to reference subcarrier power ratio exceeds a predetermined threshold;
in response to the computed AM carrier to reference subcarrier power ratio not exceeding the predetermined threshold, determining that a service mode is a first signal mode where signals are all digital; and
in response to the computed carrier to subcarrier power ratio exceeding the predetermined threshold, determining that a service mode is a second signal mode where signals comprise a combination of digital signals and analog signals.
